(19) United States
(12) Patent Application Publication
(10) Pub. No.: US 2025/0059090 A1
(43) Pub. Date: Feb. 20, 2025

(54) PROCESS FOR MANUFACTURING PELLETS FROM TAILINGS FOR USE IN ENGINEERING APPLICATIONS

(71) Applicant: PONTIFICIA UNIVERSIDAD CATOLICA DE CHILE, Santiago (CL)

(72) Inventors: MAURICIO LÓPEZ CASANOVA, Santiago (CL); FELIPE VARGAS MUÑOZ, Santiago (CL)

(73) Assignee: PONTIFICIA UNIVERSIDAD CATOLICA DE CHILE, Santiago (CL)

(21) Appl. No.: 18/725,994

(22) PCT Filed: Dec. 30, 2021
(86) PCT No.: PCT/CL2021/050133

§ 371 Date: Jul. 1, 2024

(51) Int. Cl. C04B 18/02; C04B 18/12; C04B 20/02; C04B 20/04; C04B 28/00

(52) U.S. Cl. CPC C04B 18/021; C04B 18/12; C04B 20/026; C04B 20/04; C04B 28/00

(57) ABSTRACT

The present invention relates to the manufacture of aggregates from mine tailings, and to the use of said aggregates, pellets and/or fine aggregates in engineering applications as fillers, bases and sub-bases or in concrete mixtures.

### FIELD OF APPLICATION

The present invention relates to the manufacture of artificial aggregate pellets from tailings, preferably tailings from copper mining, and at the use of these pellets as engineered solutions.

### BACKGROUND OF THE INVENTION

Aggregates are materials widely used in construction. The aggregates most commonly used in the industry have a natural origin, from sand, gravel or crushed rock, among others, and are presented in the form of medium or coarse-grained particulate material. Natural aggregates, a non-renewable natural resource, are one of the most exploited minerals, and there is a growing interest in maximizing the use of artificial aggregates to replace those of stone origin. However, the manufacture of artificial aggregates is usually expensive, as is the case of ceramic aggregates, which require the application of high temperature treatments to a raw material such as clay.

The construction industry mainly uses aggregates (gravel, fine gravel, sand, filler) either in the generation of fills and embankments to level land or build bridges, in the construction of rural roads or with road surface as bases and sub-bases, and also constitute 80% of the concrete used and 90% of the asphalt mixtures used. In the Chilean Metropolitan Region alone, more than 1800 million tons of aggregates were used in 2019. Special environmental permits are required for the extraction of aggregates, which are becoming increasingly scarce due to the environmental impacts they entail. This has caused the sources of natural aggregates to move away from centers of consumption, which has significantly increased their price and, on the other hand, encouraged the illegal exploitation of aggregates with enormous environmental impacts.

On the other hand, there are solutions related to the manufacture of artificial aggregates from recycled materials, such as plastic, or from by-products of other processes, such as aggregates made from blast furnace slag, as a non-metallic by-product, for example during the smelting of iron and steel. Artificial aggregates from recycled materials solve many industry problems, but they are often still expensive to manufacture and, in most cases, are not useful in applications where mechanical robustness is required, such as in the manufacture of concrete for construction.

Indeed, artificial aggregates are usually classified as lightweight aggregates, since they weigh less than 1 g/cm³ or even less than 0.8 g/cm³. In the latter case, lightweight aggregates are only useful in applications where mechanical robustness is not required, such as in insulation materials, as they do not have sufficient mechanical strength for use in the manufacture of construction materials.

In this sense, the mining industry generates approximately 200 tons of tailings per ton of copper produced, so that in Chile 1120 million tons of tailings were produced in 2019 that ended up in tailings dams, generating relevant environmental risks such as those associated with seismic risks and percolation of toxic metals to groundwater. This results in significant expenses for mining companies for the handling and management of tailings dams and is one of the main barriers for the generation of new mining projects or for the expansion of existing projects.

Geopolymers, on the other hand, are synthetic inorganic polymers of aluminosilicates that result from the chemical reaction known as geopolymerization. This reaction is produced by mixing aluminosilicates with concentrated alkaline activators (or less frequently with acids), commonly hydroxides and/or alkaline silicates, resulting in a new polymeric molecular network.

Geopolymerization processes are based on the formation of mineral polymers in alkaline environments at normal or high pressures (up to 35 MPa), and temperatures from ambient to 120° C., where different chemical activators (alkali metal hydroxides) and/or silicates can be used to assist in the formation of these polymers. The chemical conformation of these geopolymers, with molecular arrangements of —Si—O—Al—O— type for example, allows the use of silicates and aluminas in highly compact arrangements in high pH environments.

There are different types of geopolymers, of which the most studied have been manufactured from fly ash, blast furnace slag, metakaolin and other raw materials rich in highly reactive aluminosilicates. Geopolymers are materials with outstanding characteristics in terms of mechanical strength, fire resistance and resistance to corrosive agents. Research on environmental impact shows that geopolymers are an alternative to energy-intensive materials, such as Portland cement-based concrete, which is the most widely used construction material in the world.

To obtain geopolymers, two main components are required: first, a source rich in aluminosilicates and second, an alkaline hardener solution having an adequate concentration. One source of aluminosilicates whose implementation has been tried is obtained from mining tailings.

The traditional approach to geopolymers has been to identify particulate materials that already have a high geopolymerization potential, without prior activation processes. However, this approach limits the materials to be geopolymerizable too much, making them less competitive, since such materials, besides being scarce, can be located at great distances from the consumption centers. Consequently, implementing geopolymerization in the traditional manufacture of artificial aggregates results in economic and environmental disadvantages. In this sense, beside being useful in the context of the method of the invention, the possibility of using mining waste (environmental liability) for geopolymerization opens the doors for a greener mining that, instead of waste, delivers a competitive construction material and at the same time avoids the exploitation of natural aggregates.

In the state of the art there are solutions that attempt to address this problem. One of them corresponds to document CN111253097 where a method for preparing a geopolymeric cementitious material from molybdenum tailings is disclosed. It is stated that the geopolymeric material is prepared from solid molybdenum tailings and fly ash by a simple, low-cost, low-energy process. The method comprises mixing the molybdenum tailings with the fly ash together with solid NaOH and/or solid KOH, calcining the mixture at 500-700°° C. for 30-90 minutes, cooling and mixing the calcined mixture with water, placing the prepared mixture in a steel mold, compression molding at 10-30 MPa and curing at 40-60°° C. for 24-72 hours, thereby obtaining the geopolymeric cementing material.

Likewise, a thesis entitled “Estudio de factibiliad de obtención de hormigones poliméricos a partir de desechos minerals” (Feasibility study of obtaining geopolymer concretes from mineral wastes”) (Pedro Díaz Universidad de Chile) discloses a study about geopolymer concretes obtained from mining tailings without addition of Portland cement. According to the information contained in the thesis, it was verified that incorporation of copper tailings as a source of aluminosilicates has a negative influence on the flexural and compressive mechanical strength of geopolymer concretes, obtaining values of 0.99 and 2.99 MPa, respectively, when 100% of fly ash aluminosilicates are replaced by those of copper tailings. From the above, it can be understood that the high values of mechanical strengths (higher than 30 MPa in compression) are mainly due to the volumetric fractions of aggregates and fly ash within the geopolymer concrete.

On the other hand, pelletizing is a process that is applied to some materials, such as iron ores, in order to agglomerate very fine particles into balls of a certain size or diameter, which are known as “Pellets”. These pellets are of uniform size, high mechanical strength and high porosity.

Agglomeration of materials is recommended for very powdery materials whose smaller particles are lost as waste that cannot be used directly at the collection site.

As we have shown, in the literature and related research it is observed that there are disclosures on the geopolymerization of mine tailings for the application of solutions such as geopolymer cements and blocks. However, these solutions are limited to a geographical scope close to the tailings generation point. This is due to the difficulty of moving the dust and the environmental regulations on particulate matter that could affect the feasibility of these solutions. In view of this, there is a need for a solution to the problem of safely transferring the material for use in engineering applications (concrete mixes, fillers, bases and subbases), and at the same time provides a material obtained from copper mining tailings with good mechanical properties that make it useful for the aforementioned applications.

As noted, the invention described herein solves both problems simultaneously, generating a useful product for the construction industry.

### BRIEF DESCRIPTION OF THE INVENTION

The present invention provides a solution to the aforementioned problems by providing a pelletized product obtained from copper mining tailings, which has all the appropriate characteristics for use in civil engineering applications, in addition to being easy to transport. In this way, a product is provided that is suitable for engineering applications and of easy to transfer, at the same time that a waste material from the mining industry is used, applying circular economy. In this way, the invention solves the problems of the generation of tailings dams from the mining industry, which are an environmental liability, the extraction of natural aggregates (a non-renewable natural resource) from the construction industry, and the difficulty of transporting this type of tailings to remote locations.

### BRIEF DESCRIPTION OF THE FIGURES

As part of the present invention the following representative figures of the present invention are presented, which show preferred embodiments of the invention and, therefore, are not to be considered as limiting to the definition of the claimed subject matter.

FIG. 1: Particle size distribution graph of a set of tailings, as per example 1.

FIG. 2: Graph of thermogravimetric analysis of tailings and coactivator, according to example 1.

FIG. 3: XRD (X-ray diffraction) graph of tailings and coactivator, according to example 1.

FIG. 4: Graph of calorimetry reaction geopolymeric reaction tailing LS3, coactivator and LS3+coactivator, according to example 1.

FIG. 5: Experimental design and experimental points for mixture design, according to example 1.

FIG. 6: Graph of statistical design mechanical strength results for factors analyzed, as per example 1 for tailings LS3.

FIG. 7: Graph of statistical design mechanical strength results for factors analyzed, as per example 1 for tailings LS5.

FIG. 8: Experimental design and experimental points for pellet manufacturing, according to example 1.

### DETAILED DESCRIPTION OF THE INVENTION

The present invention relates to a pelletizing product (pellets) comprising geopolymers from copper mining tailings, the process of manufacturing said pellets and the use thereof in engineering applications, such as rolling road surfaces, bases and sub-bases and even in concretes.

In its general aspects, the proposed process requires three raw materials: (1) tailings, which can be mining tailings as a solid particulate residue obtained for example from copper milling and extraction; (2) alkaline activator corresponding to high pH reagents that can be dissolved in solution with water at different concentration; and (3) coactivator corresponding to reagents that help in the reaction.

In this context, the proposed process comprises a tailings shaping and geopolymerization process, the objective of which is to activate and harden the tailings material. Since tailings are highly variable in their mineralogical composition, the proposed process is able to easily adapt to the characteristics of each kind of tailings. This may involve variations in the proportion of tailings, coactivator and alkaline activators to be used, as well as in the molar concentration of each alkaline activator and in the hardening (curing) times and temperatures.

The activation of tailings, especially when they have a reduced geopolymerization potential, allows to improve the results of the geopolymerization process. In this context, the proposed method can comprise previous steps that allow measuring the potential of a given tailings to be geopolymerizable, and determining tailings activation treatments that allow them to reach this potential. On many occasions, tailings, which are basically ground rock in the 100-micron range, do not have the best properties to be geopolymerizable, either because they do not have certain components or because such components are poorly exposed or in a crystalline state, which gives low reactivity. The process of the invention allows exposing a greater amount of geopolymerizable materials, such as Ca, Al and Si, allowing in turn, modification of the microstructure of the tailings making it more amorphous (less crystalline) and, therefore, more reactive. Tailings activation treatments consider thermal and milling cycles that significantly alter the reactivity and geopolymerization capacity of the tailings. In addition, the use of additional coactivators such as cement or fly ash is considered, which can further enhance the results and properties of the aggregates obtained. In general, the proposed method comprises the steps of:
a) adding at least one alkaline activator, and optionally, at least one co-activator to a tailing, generating a mixture;
b) curing the mixture to at least a predetermined temperature and for at least a predetermined time; and
c) processing the mixture by pelletizing, thus obtaining an artificial aggregate.

The at least one alkaline activator can be added as a solid, when the tailing already has a moisture content, or dissolved in the form of an alkaline solution, with a molar concentration between 5 M and 10 M. Said alkaline activator can be an alkaline metal hydroxide, such as NaOH. The alkaline solution is added in an amount between 30 and 40% w/w of the tailing. According to one embodiment of the invention, the alkaline solution is added in two steps, a first portion prior to curing and a second portion during pelletizing. For example, about 80% of the solution may be added to the tailing prior to curing and the remaining 20% may be added during pelleting. Preferably, the second portion of the alkaline solution that is added during pelleting is incorporated in the form of a spray. In this context, the incorporation of the first portion of the alkaline solution can be considered as a pre-wetting step.

The at least one coactivator can be fly ash, incorporated in proportions of up to 20% w/w of the mixture. When 20% of coativator is added, the reactivity of the tailings is increased, in a proportion greater than that which would result from addition of the results obtained by addition of those attributable to each activator separately, that is, the sum of the two compounds, activator and coactivator, generates a greater reactivity than the individual action of each one in the proportions contained in the mixture. Other materials that can be used as coactivators are kaolin, calcined clay or cement.

The curing step of the mixture requires exposure of the mixture for a certain time at elevated temperature, for example between 23°° C. and 70° C. In one embodiment a curing step for 7 days at a temperature of 60° C. can be used. The curing temperature is intended to accelerate the geopolymerization process, and different combinations of time and temperature can be used to achieve the desired result. Alternatively, curing is done in two steps, applying high temperature (60-70° C.) for 7 days and then curing at room temperature for some time.

On the other hand, pelletizing seeks to improve the manufacturing conditions of artificial aggregates, so that the process is easily scalable. It was determined that pelletizing angles between 30° and 60° are preferred for obtaining pellets of desirable quality in terms of shape and size. A pelletizing device of variable speed and angle of rotation can be used for pelletizing, so as to form aggregates of regular shape, preferably circular, and of suitable size, preferably between 5 mm and 19 mm. Preferably, speeds of between 20 and 50 rpm and angles of between 30 and 60° are implemented. Furthermore, the pelletizing device may be adapted to receive the second portion of the alkaline solution, which may be added during pelletizing in the form of a spray.

Alternatively, the tailings can be pre-treated prior to the aggregation of the activator and coactivator. Such pretreatment of the tailing can be by grinding, to obtain a suitable particle size, or by heat treatment, to generate crystalline transformations, and/or by incorporation of adjuvants such as calcium carbonate or calcium hydroxide, mainly to provide elements that favor geopolymerization reactions, such as calcium. In the case of adjuvant incorporation, they can be added, for example, in amounts up to 10% w/w of the mixture.

Finally, the process of the invention may also contemplate, initially, a first step of tailings characterization, the objective of which is to determine the type of tailings to be processed in order to adjust the parameters of the proposed process so as to optimize aggregate production. As mentioned above, tailings are highly variable in their mineralogical composition and, although the developed process is applicable to a wide variety of tailings of different origin, it may be desirable to know the characteristics of the tailings in advance, with a view to optimizing aggregate production according to the needs of each application. The process of the invention is versatile in the adjustment of different operating parameters, such as the amount and concentration of activators and coactivators, the curing temperature and time, and the pelletizing angle and size, adjustments which can be optimized according to the type of tailings to be processed.

When the first step of tailings characterization is applied, the aim is to perform an elemental analysis of the tailings, i.e., to identify the elements available in the tailings for the geopolymerization process. In addition, by characterizing the tailings it is possible to identify the particle size distribution of the tailings, which allows a determination of whether they have an adequate size for the generation of reactions. This information can be used not only in the adjustment of the parameters of the proposed methodology, but also in the pretreatment step of the tailings, if applied, for example, by grinding to adjust the particle size.

### PREFERRED EMBODIMENTS OF THE INVENTION

The present invention relates to a process for manufacturing pellets from mine tailings comprising the following steps:
selecting tailings having an aluminosilicate content greater than or equal to 4% (determined as aluminum oxides) and a sulfate content less than or equal to 15% (determined as oxide);
adding an alkaline activator;
pre-mixing solids and alkaline activator to form seeds;
pelletizing the formed seeds; and
curing the pellets formed.

In a preferred embodiment of the invention the process for manufacturing pellets comprises reducing the size of the tailings once selected.

In another preferred mode of the invention the process comprises calcining the selected tailings at a temperature of up to 900°° C.

In yet another preferred embodiment of the invention, the process comprises adding to the selected material a co-activator selected from fly ash, kaolin, calcined clay, metakaolin, Ca(OH)₂, cement, rice husk ash, biosolids ash, municipal waste ash, other organic or volcanic material ash and/or mixture thereof, wherein the alkaline activator is added as a solid or in solution, wherein the alkaline activator in solution is added in an amount between 15 and 50% mass/mass with respect to the solids, with a molar concentration between 5 M and 17.5 M, and the alkaline activator when incorporated in solution form is added in an amount of 60% and 100% with respect to the total alkaline solution.

In one embodiment of the invention, the formed seeds have a size of up to 5 mm.

In another embodiment of the invention during the pelleting step of the process the seeds are wetted with a solution of the alkaline activator.

In a preferred embodiment of the invention, the pelletizing is performed using a pelletizing plate at a cutting angle between 40° and 60°.

In another embodiment of the invention the curing is performed at a temperature of up to 95° C. for up to 14 days.

In one embodiment of the invention after the temperature curing step a curing step of the formed pellets is performed at room temperature.

The present invention also relates to a process for manufacturing fine aggregates from mine tailings, comprising the following steps:
selecting tailings having an aluminosilicate content greater than or equal to 4% (determined as aluminum oxides) and a sulfate content less than or equal to 15% (determined as oxide);
adding an alkaline activator;
pre-mixing solids and alkaline activator to form seeds;
curing the formed seeds.

In a preferred embodiment of the invention the process for preparing fine aggregates comprises reducing the size of the tailings once selected.

In another preferred mode of the invention the process comprises calcining the selected tailing at a temperature of up to 900° C.

In yet another preferred embodiment of the invention, the process comprises adding to the selected material a co-activator selected from fly ash, kaolin, calcined clay, metakaolin, Ca(OH)₂, cement, rice husk ash, biosolids ash, municipal waste ash, other organic or volcanic material ash and mixture thereof, wherein the alkaline activator is added in solid form or in solution, wherein the alkaline activator in solution is added in an amount between 15 and 50% mass/mass with respect to the solids, with a molar concentration between 5 M and 17.5 M, and the alkaline activator when incorporated in solution form is added in an amount between 60% and 100% with respect to the total alkaline solution.

In one embodiment of the invention, the formed seeds have a size of up to 5 mm. In another embodiment of the invention the curing is performed at a temperature of up to 95° C. for up to 14 days.

In one embodiment of the invention after the temperature curing step a curing step of the formed aggregates is performed at room temperature.

The present invention also relates to pellets and fine aggregates obtained by means of the preceding processes.

In one embodiment of the invention the pellets have a size between 5 and 40 mm.

In another embodiment of the invention the fine aggregates have a size of up to 5 mm. Finally, the present invention is directed to the use of the manufactured pellets and fine aggregates for civil engineering applications. Preferably, they are employed in fillers, bases and sub-bases or in concrete mixes.

### EXAMPLE

Mining tailings, such as copper mining, have typical chemical characteristics that can be summarized as: low reactivity, high quartz content and particle size close to 100 microns on average. By implementing the invention, it is possible to activate the tailings and, by means of forming and geopolymerization processes, obtain tailings with desirable mechanical properties.

The methodology begins with an elemental analysis of the tailings, or tailings characterization, which is an indicator of possible elements available for geopolymerization processes.

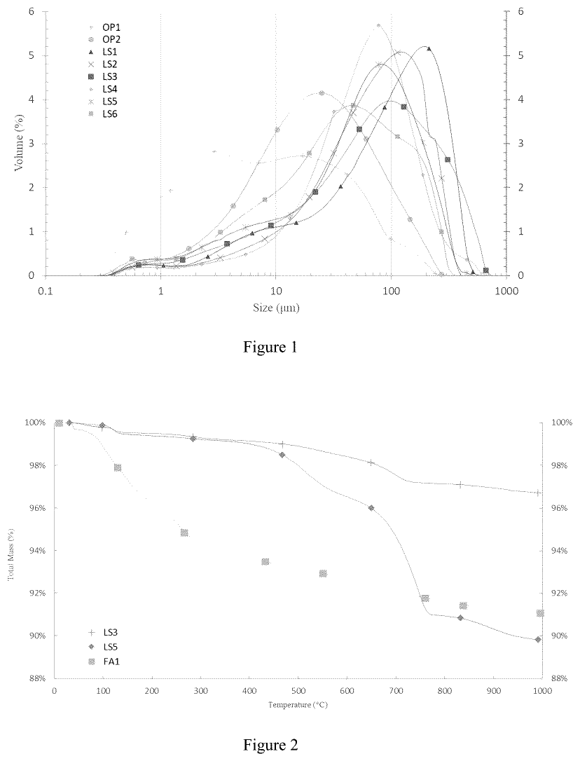

Table 1 shows the elemental composition of a set of tailings originally studied, two of which were selected for their aluminate content (referred to in this case as the presence of aluminum oxide) and calcium phase content (referred to in this case as the presence of calcium oxide), both as an initial indicator of possible geopolymerizable phases. In this case, the particle size distribution of the tailings is also observed (see FIG. 1), which allows determining if whether they have an adequate size for the generation of reactions, understood as a size ideally below 100 microns, making the simile with cementitious reactions, where sizes below 70 microns are sought for hydration reactions from the physical point of view.

TABLE 1
Elemental composition of tailings under study by XRF (X-Ray Fluorescence).

| Percentage | | | | | | | | |
|---|---|---|---|---|---|---|---|---|
| of oxides | GP1 | GP2 | LS1 | LS2 | LS3 | LS4 | LS5 | LS6 |
| SiO₂ | 62.90% | 59.90% | 49.40% | 60.20% | 51.90% | 73.70% | 42.60% | 31.80% |
| AI O₂₃ | 9.50% | 16.90% | 10.30% | 12.20% | 16.70% | 5.40% | 8.80% | 6.90% |
| Fe O₂ | 12.60 | 2.80% | 18.70% | 7.00% | 30.60% | 12.50% | 11.00% | 37.90% |
| CaO | 2.80% | 2.70% | 5.10% | 5.90% | 4.40% | 1.80% | 12.70% | 8.60% |
| MgO | 1.10% | 1.90% | 2.70% | 1.70% | 3.80% | 0.50% | 2.50% | 2.40% |
| SO₃ | 0.70% | 1.30% | 2.60% | 1.40% | 0.40% | 0.40% | 1.80% | 0.10% |
| Na O₂ | 1.30% | 3.20% | 1.30% | 2.30% | 3.80% | 0.50% | 1.60% | 2.70% |
| K O₂ | 3.30% | 4.10% | 2.60% | 2.60% | 2.90% | 1.30% | 1.80% | 1.80% |
| TiO₂ | 0.20% | 0.70% | 0.50% | 0.70% | 1.10% | 0.40% | 0.40% | 0.50% |
| P O₂₅ | 0.10% | 0.30% | 0.20% | 0.30% | 0.40% | 0.10% | 0.10% | 0.10% |
| MnO | 0.10% | <LOD | 0.20% | 0.10% | 0.30% | 0.10% | 0.70% | 0.20% |
| CuO | 0.70% | 0.100% | 0.30% | 0.80% | 0.70% | 0.40% | 0.20% | 0.30% |
| LOI | 4.40% | 5.30% | 5.80% | 4.20% | 2.80% | 300% | 14.50% | 6.40% |
| Specific | 3.01 | 2.99 | 2.93 | 2.79 | 2.78 | 2.89 | 2.86 | 3.21 |
| Gravity | | | | | | | | |

In all tailings a particle size suitable for the pursuit of the geopolymerization process is observed, however, the elemental composition shows that those tailings with higher aluminum and calcium content are more likely to be possible candidates for a successful geopolymerization process in the first instance. This is without considering that, subsequently, the tailings can be mechanically pretreated to reduce their particle size in order to make them more reactive or to make available phases that can react. In addition, thermal pretreatment can be applied later, which modifies crystalline phases. LS3 and LS5 tailings were selected at this step.

Considering the above, a space of interest is established for the elaboration of pelletized aggregates from mining tailings that, preferably, meet chemical and physical requirements in the particles to be agglomerated:
Elemental composition with aluminum oxides content higher than 4%, preferably higher than 8%.
Particle size p (0.9) (90% of particles) less than 150 microns.
Sulfate content less than 10%, measured as oxides.

Subsequently, a thermogravimetric analysis (TGA) is performed, which allows one to see certain chemical compositions and evaluate if there is a possibility of crystalline transformations before thermal treatments. FIG. 2 shows a thermogravimetric analysis of tailings that, for the selected tailings, shows the existence of phases that can increase their cementitious and geopolymeric capacity especially between 700 and 800° C., for LS5tailing. In the case of LS3 tailings, no important modifications in the crystalline structure or loss of phases such as carbonates (which can be seen between 400° C. and 600° C.) are observed.

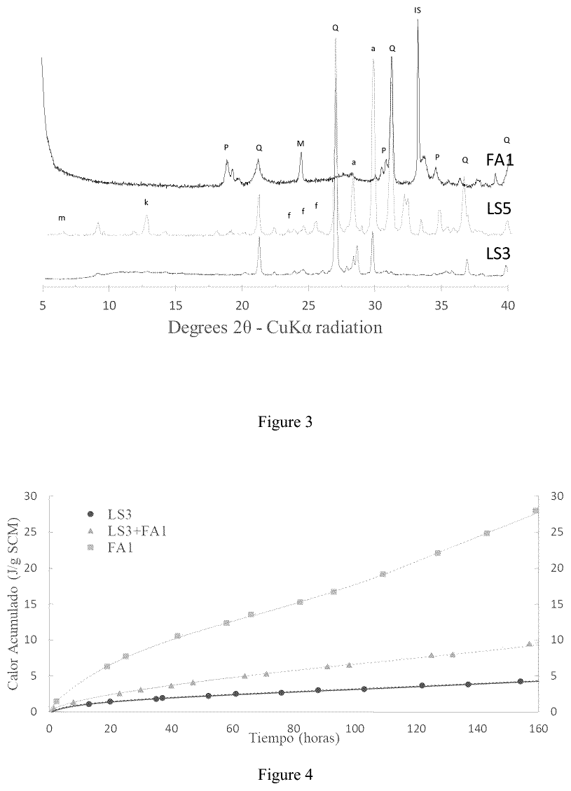

Finally, the above can be verified by X-ray diffraction analysis (XRD), as shown in FIG. 3, where typical crystalline phases in tailings can be observed, mainly quartz, which is highly crystalline and not very reactive, and other phases that can be modified by thermal treatment such as dolomites and carbonates (by decomposition) as well as phases such as kaolinites and feldspars in the case of LS5. LS3 tailing is not very modifiable, however, this may be related to the presence of amorphous phases in the case of aluminates and calcites necessary for geopolymerization reactions.

Finally, by means of isothermal calorimetry it was tested how the addition of some coactivator can generate an improvement in the reactivity in the geopolymeric processes, observing that when 20% of ash is added as a coactivator, the reactivity is increased in a higher proportion than what is represented by the addition by itself, that is, the sum of the two compounds generates a higher reactivity than the individual action of each one in the proportions contained in the mixture. The results of this test can be seen in FIG. 4, using geopolymeric reaction calorimetry LS3 tailing and coactivator (FA1) alone, in addition to LS3+FA1. FIG. 2 and FIG. 3 also include data for co-activator (FA1) alone.

Based on these results, an experimental design was established for geopolymer mix design factors, considering that these tailings will not be treated in a first step (but taking into account that the strength can be improved with a calcination of up to) 800°. The purpose of this design is to measure which experimental point provides the best mechanical resistance, in order to later manufacture aggregates with this experimental point.

The experimental design considered the following mix design factors:
Addition of calcium hydroxide as an adjuvant in a pre-treatment of the tailings, this in order to provide the calcium that may be necessary for the reactions, up to 10%.
Addition of coactivator (ash): in this case, up to 20%, to provide early strength and missing materials that may be required for the geopolymerization reaction. In this case, fly ash was used; however, other materials such as kaolin, calcined clay or cement can be used.
Concentration of alkaline activator (NaOH): in solution, considering between 5M and 10M.
Curing temperature: the temperature accelerates the geopolymerization processes, tested between room temperature (23°° C.) and 70°° C. This curing was carried out during the first 7 days of the reaction and then cured at room temperature.
Amount of solution: mainly water with dissolved alkaline activator. Between 30 and 40% w/w of the powders were tested.

The experimental design allowed analyzing trends and searching for the best point of the design. The design was optimized to reduce the number of trials, as shown in FIG. 5, where the experimental design and experimental points for each mix design are shown.

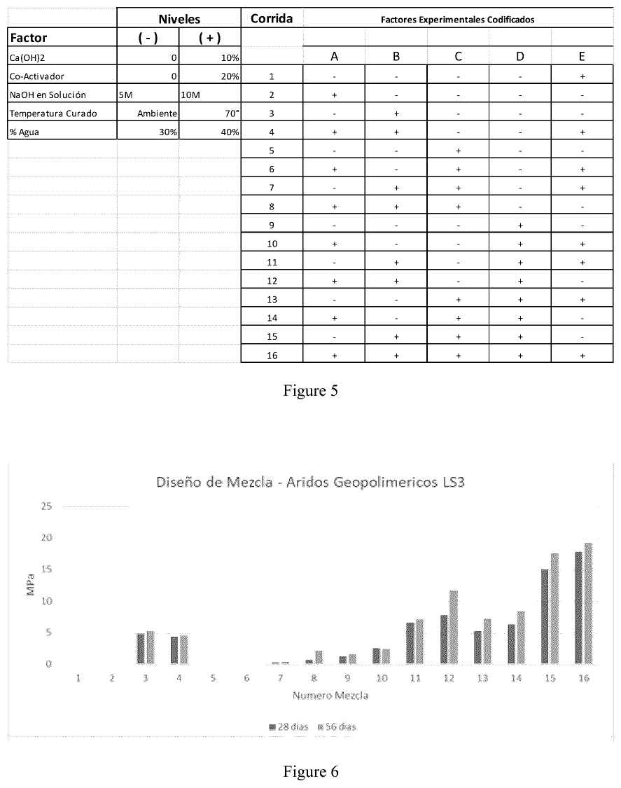

The statistical design mechanical strength results for the factors analyzed can be seen in FIG. 6, where it is observed that in general the incorporation of calcium and coactivator additions has a positive impact on strength, as does the incorporation of larger amounts of activator in the form of molar concentration in the solution, although statistically the amount of water was not shown to be relevant. The process development temperature is also statistically relevant (being the most influential factor in this process), followed by the presence of coactivator and the molar concentration factor (discounting the combinations of these factors).

Considering these results, work continues with LS3 tailing, which had previously been shown to be less reactive or less likely to be reactive but obtains a higher strength (18 MPa at 28 days and 19 MPa at 56 days).

With this design, LS3 tailings were chosen for the manufacture of aggregates in a pelletizer, in mix designs 15 and 16 and analyzing 3 variables:
Rotation speed, where it is tested which speed allows the formation of aggregates of regular shape (medium circular) and adequate size (not sand size, between 5 mm and 19 mm). Two rotation speeds are tested at 20 rpm and 50 rpm.
Pelletizer rotation angle, in the same manner, to test for proper pellet/aggregate formation, testing 2 angles at 30° and 60°.
Solution feeding method, where the way in which the solution is added to the aggregates varies, choosing between incorporating all the alkaline solution before the pelletizing process or occupying 80% of the solution and then introducing the remaining 20% as a spray.

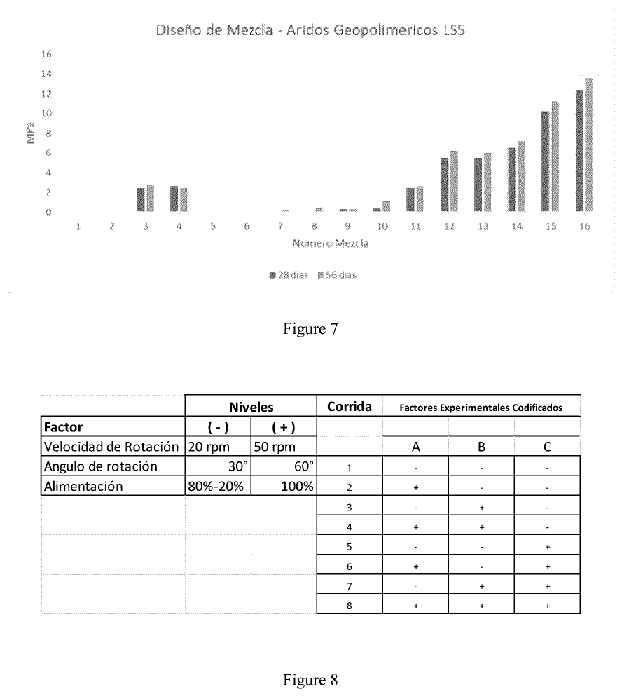

The experimental design for pellet manufacturing can be seen in FIG. 7, with the consequent experimental runs.

The results of this design allowed determining that, in general, the aggregation of the alkaline solution in separate portions, before curing and during pelletizing, is favorable for pellet formation. In the case of speed and angles, these results are similar to those previously observed with the manufacture of pellets with fly ash alone: angles close to 60° and speeds above 45 rpm allowed the formation of aggregates effectively. In this sense, we chose to use aggregates manufactured using an angle of 60° and 50 rpm, with a feed based on 80% alkaline solution in a premixing process, and the remaining 20% as a spray.

With this process, aggregates of mix designs 15 and 16 were manufactured to measure their absorption, density and impact resistance properties using the Impact Value test (BS812-112 standard), in order to relate this resistance to their possible uses in engineering applications. The density measurements yielded values of 1.9932 and 2.1214 for each of the mix designs (15 and 16), with absorption measurements of 21% on average, which makes it feasible to use these aggregates as internal curing agents in other applications in the future (providing water in hydration processes).

Impact Value measurements resulted in 29.2% for mix design 15 and 26.4% for mix design 16. Here the resistance values were inverted with respect to the original mix design, which could be due to the manufacturing processes where more variables are introduced. In any case, these values allow its use as a base and subbase material, even making it possible to use it to manufacture road surfaces (values between 20 and 30%) and even concretes for use in pavements (values lower than 45%).

The above example shows that the application of the methodology developed, whose scheme is shown in FIG. 8, proposes a viable alternative to the manufacture of artificial aggregates from recycled materials, in this case, from mine tailings.

By way of conclusion, it is important to highlight that the process proposed by the present invention has as clear advantages the agglomeration of mining waste (tailings) that would otherwise form an environmental liability with no known use other than its deposit, transforming them into construction materials (fine aggregates and coarse aggregates in the form of pellets) that have different applications in high demand civil engineering works; transformation and processing that is carried out easily and without complex industrial processes, with highly available materials for their execution, including scientific analysis techniques for the optimization of their functional properties for engineering and construction, with the additional advantage of being feasible to be transported like any other aggregate.

The foregoing specification is considered only illustrative of the principles of the invention. The scope of the claims should not be limited by the example embodiments set forth in the preceding section but should be given the broadest interpretation consistent with the specification as a whole.

1. A process for manufacturing pellets from mine tailings, characterized in that said process comprises the following steps:
selecting tailings having an aluminosilicate content greater than or equal to 4% (determined as aluminum oxides) and a sulfate content less than or equal to 15% (determined as oxide);
adding an alkaline activator;
pre-mixing solids and alkaline activator to form seeds;
pelletizing the formed seeds; and
curing the pellets formed.

2. The pellet manufacturing process according to claim 1, characterized in that it comprises reducing the size of the tailings once selected.

3. The pellet manufacturing process according to claim 1, characterized in that it comprises calcining the selected tailing at a temperature of up to 900° C.

4. The pellet manufacturing process according to claim 1, characterized in that it comprises adding to the selected material a co-activator selected from fly ash, kaolin, calcined clay, metakaolin, Ca(OH)₂, cement, rice husk ash, biosolids ash, municipal waste ash, other organic or volcanic material ash and/or mixture thereof.

5. The pellet manufacturing process according to claim 1, characterized in that the alkaline activator is added as a solid or in solution.

6. The pellet manufacturing process according to claim 5, characterized in that the alkaline activator is added in solution is added in an amount between 15 and 50% mass/mass with respect to the solids, with a molar concentration between 5 M and 17.5 M.

7. The pellet manufacturing process according to claim 5, characterized in that the alkaline activator when is incorporated as a solution and is added in amount of 60% and 100% with respect to the total alkaline solution.

8. The pellet manufacturing process according to claim 1, characterized in that the formed seeds are up to 5 mm in size.

9. The pellet manufacturing process according to claim 1, characterized in that during the pelleting step the seeds are wetted with an alkaline activator solution.

10. The pellet manufacturing process according to claim 1, characterized in that the pelletizing is performed using a pelletizing plate at a cutting angle between 40 and 60°.

11. The pellet manufacturing process according to claim 1, characterized in that curing is performed at a temperature of up to 95° C. for up to 14 days.

12. The pellet manufacturing process according to claim 1, characterized in that after the temperature curing step a curing step of the formed pellets is performed at room temperature.

13. A process for the manufacture of fine aggregates from mine tailings, characterized in that it comprises the following steps:
selecting tailings having an aluminosilicate content greater than or equal to 4% (determined as aluminum oxides) and a sulfate content less than or equal to 15% (determined as oxide);
adding an alkaline activator;

14. The process of manufacturing fine aggregates according to claim 13, characterized in that it comprises reducing the size of the tailings once selected.
pre-mixing solids and alkaline activator to form seeds;
curing the formed seeds.

15. The fine aggregate manufacturing process according to claim 13, characterized in that it comprises calcining the selected tailings at a temperature of up to 900° C.

16. The fine aggregate manufacturing process according to claim 13, characterized in that it comprises adding to the material a co-activator selected from fly ash, kaolin, calcined clay, metakaolin, Ca(OH)₂, cement, rice husk ash, biosolids ash, municipal waste ash, other organic or volcanic material ash and mixture thereof.

17. The fine aggregate manufacturing process according to claim 13, characterized in that the alkaline activator is added as a solid or in solution.

18. The fine aggregate manufacturing process according to claim 17, characterized in that the alkaline activator in solution is added in solution in an amount between 15 and 50% mass/mass with respect to the solids, with a molar concentration between 5 M and 17.5 M.

19. The fine aggregate manufacturing process according to claim 17, characterized in that the alkaline activator in solid form is added in solid form in amount of 60% and 100% with respect to the total alkaline solution.

20. The fine aggregate manufacturing process according to claim 13, characterized in that the formed seeds are up to 5 mm in size.

21. The fine aggregate manufacturing process according to claim 13, characterized in that the curing is performed at a temperature of up to 95° C. for up to 14 days.

22. The fine aggregate manufacturing process according to claim 13, characterized in that after the temperature curing step, a curing step of the fine aggregates formed at room temperature is performed.

23. Pellets, characterized in that they are obtained by the process according to claim 1.

24. Pellets according to claim 23, characterized in that they have a size between 5 mm and 40 mm.

25. Fine aggregates, characterized in that they are obtained by the process according to claim 13.

26. Fine aggregates according to claim 25, characterized in that they have a size of less than 5 mm.

27. Pellets according to claim 23, when used in civil works applications.

28. Pellets according to claim 25, when used in backfills, bases and sub-bases or in concrete mixes.

29. Fine aggregates according to claim 25, when used in civil works applications.

30. Fine aggregates according to claim 29, when used in fillers, bases and sub-bases or concrete mixes.
